(19) United States
(12) Patent Application Publication
(10) Pub. No.: US 2005/0044756 A1
(43) Pub. Date: Mar. 3, 2005

(54) Disposable promotional items with built in DTMF tones

(76) Inventor: Fred J. Abrahams, New York, NY (US)

Correspondence Address: JENNIFER MEREDITH, 315 PARK AVENUE SOUTH, FLOOR 19, NEW YORK, NY, 10010, US

(21) Appl. No.: 10/648,102

(22) Filed: Aug. 25, 2003

(51) Int. Cl. G09F 1/00

(52) U.S. Cl. 40/124.03; 340/384.7

(57) ABSTRACT

The present invention provides systems and methods for producing, using and manufacturing a promotional item, such as a phone card device, which is capable of emitting a pre-programmed series of Dual-Tone Multi-Frequency (DTMF) tones at a specific time, as invoked by the user. These tones can dial a pre-programmed telephone number, invoke a specific long-distance carrier, call help or customer service numbers or activate a calling card service for a call.

### BACKGROUND OF THE INVENTION

The present invention relates to methods and systems for disposable promotional items which emit Dual-Tone Multi-Frequency (DTMF) tones into a telephone receiver, simulating a user dialing a pre-determined sequence of numbers. This can include invoking the use of a calling card or dialing a pre-determined telephone number. This could prove to be a particularly useful tool for marketing a pre-paid phone card or direct dial long distance service (i.e. 10-10-220 or 10-10-987), as potential users would not even need to remember a sequence of numbers to dial, the pre-programmed tones within the card would enter all necessary information. Also, it is envisioned that promotional give-aways, such as pens for pharmaceutical companies may be programmed to dial the DTMF tones.

The current market employs a plethora of devices with capabilities to generate sounds, but none specifically designed to produce DTMF tones in disposable items. In U.S. Pat. No. 5,275,285 issued to Clegg, a business card holder with a sound generating microchip is disclosed. The card holder as disclosed by Clegg, includes a sound emitting device incorporated within the holder. When the holder is opened or unfolded, the sound-emitting device is activated to provide a pre-programmed audio signal to the recipient.

A card assembly, as disclosed in U.S. Pat. No. 5,761,836, issued to Dawson, also includes a device for playing an auditory message. This is accomplished by interfacing mounting slots for holding a small card or gift item, and connecting these slots to the electrical circuit of the device. When seated in the slots, the card disrupts the electrical circuit of the device, thus preventing playback of the tune or message. Upon removal, the circuit closes and the stored message can be played.

U.S. Pat. No. 5,539,819 issued to Sonoyama, discloses a credit card which generates a DTMF tone. While this is a similar invention, there are multiple significant differences from the current subject of invention. The credit card capability and use of a magnetic strip and solar powered battery make Sonoyama's disclosure a permanent device, intended for long-term usage. Additionally the ability to have a series of numbers stored and allow the user to select the sequence of DTMF tones to be played. The current invention discloses a short-term use, disposable apparatus designed to be used for only a short period of time and discarded. Furthermore U.S. Pat. No. 6,183,017, issued to Najor discloses a calling card coupon, however Najor's disclosure does not include the ability to emit DTMF tones as the current subject of invention does.

In an alternate field of products, greeting cards have been produced with sound emitting microchip devices. These cards often provide a digital musical accompaniment, when the card is opened. This accompaniment typically follows the words in the card or fits the mood of the card. In some greeting cards, the emitted music tends to be fanciful tunes or partial renditions of familiar musical works, with the purchaser being limited to the sound selection currently incorporated in the greeting card. Typically, these cards are also preprinted with a greeting or message. There are musical greeting cards and combined greeting card with musical box structures that include a greeting card and a musical sound being produced upon activation of a spring loaded actuator pin, such as that disclosed in U.S. Pat. No. 3,798,806, issued to Sanford and U.S. Pat. No. 4,102,067, issued to Tarrant. The Sanford and Tarrant patents disclose devices that require the activation of the actuator pin before sound is produced. Further, no greeting cards emit a DTMF tone, nor disclose the pre-programmed phone number to dial into a telephone provider.

These greeting cards most commonly include a miniature, battery powered, printed circuit board (PCB) with a small memory chip including tone instructions, a piezo-electric buzzer and a switch. One side of the switch is connected to the PCB, while the other is connected to the battery. When the card is closed the switch is in the off position. Opening the card, also opens the switch, thus completing the circuit and allowing the pre-programmed tune to sound.

Other similar devices include a talking entertainment card as disclosed in U.S. Pat. No. 5,433,035, issued to Bauer. This type of device, while performing a similar action is made for a longer term usage and is assembled using more durable parts and allows the user to replace the battery, thus extending usage life.

### SUMMARY OF THE INVENTION

One embodiment of the current subject of invention is a method of manufacturing a disposable, Dual-Tone Multi-Frequency (DTMF) tone emitting promotional item. This process includes forming a disposable base, attaching a power supply means to the disposable base, attaching a programmable chip to the disposable base, attaching a first terminal of a micro-switch to the power supply and a second terminal to the programmable chip. The method further includes providing a trigger means for tripping the micro-switch, and the attachment of a speaker to the programmable chip. This speaker is configured to emit a pre-programmed sequence of Dual-Tone Multi-Frequency (DTMF) tones when the triggering mechanism trips the micro-switch.

Another embodiment describes a device for promoting and automatically dialing a phone number which includes a disposable base, a power supply, a programmable chip and a micro- switch connected between the power supply and programmable chip. The programmable chip is connected to a speaker which emits a pre-programmed sequence of Dual-Tone Multi-Frequency (DTMF) tones which automatically dials a telephone connection provider when the micro-switch is tripped.

Another preferred embodiment is a method for promoting a phone number which includes the steps of providing a disposable base which has a pre-programmed sequence of DTMF tones, provided in return for payment of the initial balance on an account. The user triggers the disposable base to emit the pre-programmed DTMF tone into the receiver of a telephone device in response to a trigger action by the user. Once the card is triggered, the sequence of DTMF tones emitted connects the user with a telephone service provider.

Yet another preferred embodiment is a method for providing and using a calling card comprising first the step of forming a disposable base to which a power supply, a programmable chip and a speaker can be attached. A micro-switch is interfaced into the system between a terminal of the power supply and the programmable chip. Finally, a speaker is attached to the chip, configured to emit a pre-programmed sequence of DTMF tones when the switch is tripped. The disposable base is typically a calling card and is provided to the user in exchange for a payment corresponding to an initial balance of an account. Pressing a button, removing a tab or unfolding the card triggers the card. Triggering the card, results in the speaker emitting a pre-programmed series DTMF tones into the receiver of a telephone device. This results in the user being connected with a telephone service provider.

Another embodiment is a method for using a calling card which includes the steps of providing a disposable calling card which has a pre-programmed sequence of DTMF tones, provided in return for payment of the initial balance on an account. The user can trigger the calling card to emit said pre-programmed DTMF tone into the receiver of a telephone device in response to a trigger action by the user. Once the card is triggered, the sequence of DTMF tones emitted connects the user with a calling card service provider and enters the corresponding account identification information.

Yet, another embodiment is a method for providing and promoting a calling card comprising the steps of forming a blank to which a power supply, a programmable chip and a speaker can be attached. A micro-switch is attached with a first terminal attached to the power supply and the second terminal attached to the programmable chip. Finally, a speaker is attached to the chip, configured to emit a pre-programmed sequence of DTMF tones when the switch is tripped. This card is provided to the user in exchange for a payment corresponding to an initial balance of an account. Pressing a button, removing a tab or unfolding the card triggers the card. Triggering the card, results in the speaker emitting a pre-programmed series DTMF tones into the receiver of a telephone device. This connects the user with a calling card service provider and enters the corresponding account identification information.

This summary is not to be taken in a limiting sense, but is made merely for the purpose of illustrating the general principles of the invention, since the scope of the invention is best defined by the appended claims.

### BRIEF DESCRIPTION OF THE DRAWINGS

FIG. 1 depicts a phone card device according to the present invention;

FIG. 2 depicts a flow chart detailing a method of manufacturing a phone card;

FIG. 3 depicts a flow chart detailing a method for promoting a phone number;

FIG. 4 depicts a flow chart detailing a method for providing and using a calling card is depicted;

FIG. 5 depicts a flow chart detailing a method for providing and using a calling card is depicted; and

FIG. 6 depicts a flow chart detailing a method for providing and promoting a calling card

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

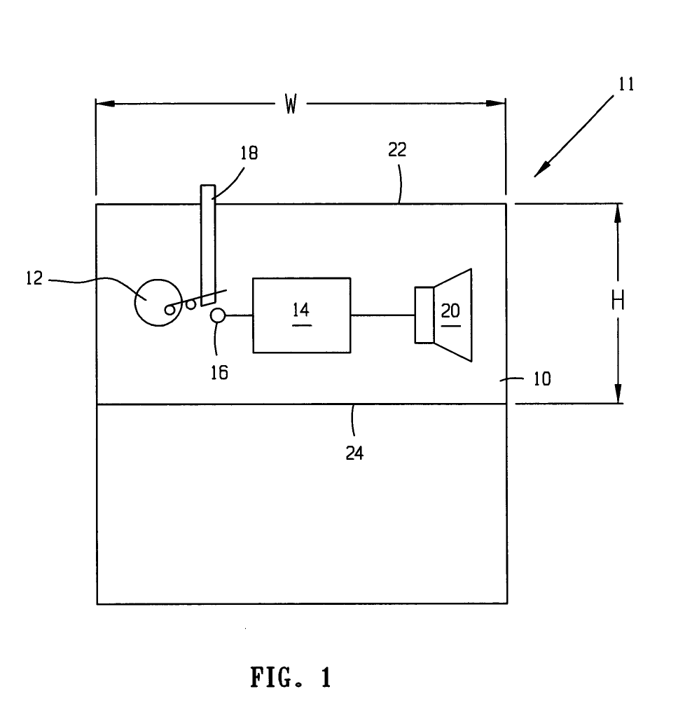

FIG. 1 depicts a disposable, DTMF tone emitting promotional item, specifically a phone card device 11 according to the present invention. As shown, there may be a disposable base 10, a power supply means as a battery 12 attached to the disposable base 10, a programmable chip 14 also attached to the disposable base 10, a micro-switch 16 with a first terminal attached to the battery 12 and a second terminal attached the programmable chip 14, a trigger means 18 is in communication with the micro-switch 10 and the programmable chip 14; a speaker 20 which emits a pre-programmed sequence of Dual-Tone Multi-Frequency (DTMF) tones which automatically dials a telephone connection provider when the micro-switch is trigger means 18 is tripped. The phone card 11 may be made from paper, cardboard or plastic and is ideally the size of a business card. The disposable base 10 as shown is the size of a business card when folded, being approximately between 88 mm and 95 mm (width), 45 mm and 60 mm (height), preferably 90 mm (width) and 55 mm (height). The thickness of the card should be as thin as possible, preferably less than ⅛ of an inch or between 2 and 4 mm (depth). The disposable base 10 may be the size single fold or bi-fold. According to a preferred embodiment the blank is made of paper. Where the phone card has a fold 24, unfolding the card trips the micro-switch and activates the speaker to play a series of pre-programmed DTMF tones. As shown the disposable base 10 is formed to provide a creased side 24 and an open side 22, and upon unfolding along the open side 22 the speaker 20 is activated to play a series of pre-programmed DTMF tones. FIG. 1 depicts the phone card 11 in the open position. It should be understood that the disposable base as shown is a business card, however, it is envisioned that the disposable base may also be a pen, pencil or key chain ornament. It is also envisioned that the present invention may be attached to a product and automatically dial a customer service number. For example, a mobile phone, enclosed in the packaging is a card or ornament attached thereto, the user triggers the item to dial a number that starts the activation process. As another example, a AAA card that automatically calls the help number upon opening.

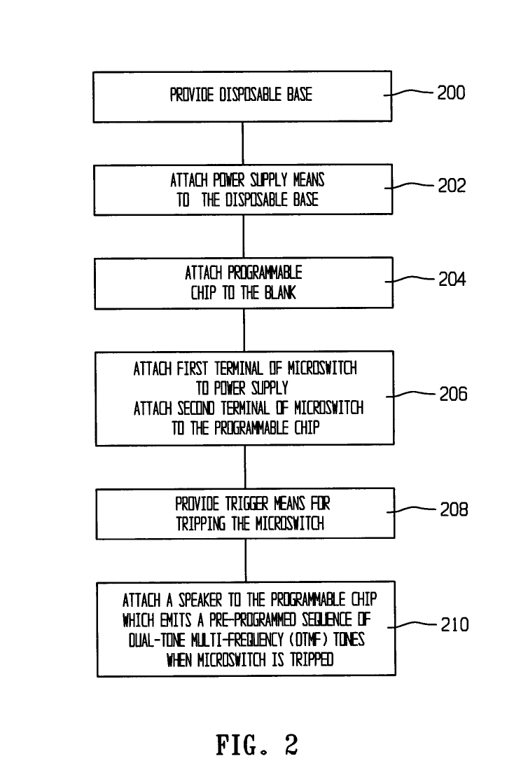

FIG. 2 depicts a flow chart detailing a method of manufacturing a phone card. As shown, a method of manufacturing a disposable, DTMF tone emitting promotional item comprising: step (200) providing a disposable base. The disposable base may be made of paper, cardboard or plastic and may be a business card, standard business card, single fold business card, bi-fold business card, pen, pencil and key chain. Step (202) attaching a power supply means to the disposable base. The power supply means may be a battery, including power paper batteries. Step (204) may be attaching a programmable chip to the blank. This may be accomplished by gluing, folding within the blank or any other method known within the art. Step (206) attaching a first terminal of a micro-switch to the power supply and a second terminal of the micro-switch to the programmable chip. Step (208) providing a trigger means for tripping the micro-switch. Step (210) attaching a speaker to the programmable chip which emits a pre-programmed sequence of Dual-Tone Multi-Frequency (DTMF) tones when the micro-switch is tripped. The pre-programmed sequence may be a telephone connection provider. This would be ideal for pre-paid phone cards. U.S. Pat. No. 4,706,275 discloses systems and methods for providing pre-paid telephone calls and is incorporated herein by reference. As described, telephone calls may be made from any available telephone, the method comprising the steps of: obtaining a special code by depositing a prepayment amount; storing the prepayment amount in a memory in a special exchange for use in verifying calling party calls; dialing the special exchange when a telephone call connection is desired; inputting such special code for verification; inputting the number of the called party; verifying the special code and comparing the prepayment amount less any deduction for previous calls in the memory and the minimum cost of the inputted call; connecting called party to the calling party in response to the verification; monitoring the prepayment amount less deductions for the running cost of the call; and disconnecting the call when the prepayment amount has been spent. The telephone connection provider may be a third party and the number may be written on the disposable base or anywhere on the promotional item. There may also be a designated area, such as a line or blank, where a third party's telephone number can be written. It is also envisioned that card may be provided for future programming by a manufacturer.

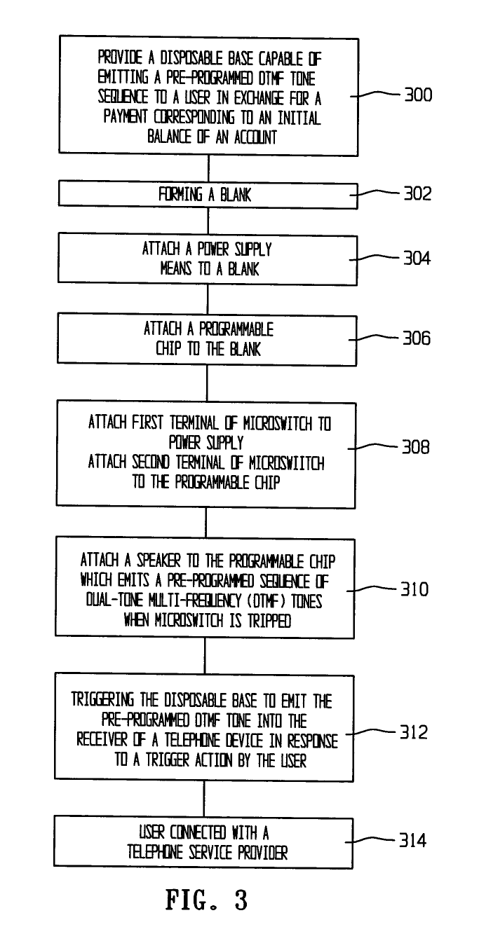

FIG. 3 depicts a method for promoting a phone number, the method comprising the steps of: step (300) providing a disposable base capable of emitting a pre-programmed DTMF tone sequence to a user in exchange for a payment corresponding to an initial balance of an account. The step of providing a disposable base may optionally consist of the steps (302) forming a blank; step (304) attaching a power supply means to a blank; step (306) attaching a programmable chip to the blank; step (308) attaching a first terminal of a micro-switch to the small battery and a second terminal of the micro-switch to the programmable chip; and step (310) attaching a speaker to said programmable chip which emits a pre-programmed sequence of Dual-Tone Multi-Frequency (DTMF) tones when said micro-switch is tripped. Step (312) triggering the disposable base to emit the pre-programmed DTMF tone into the receiver of a telephone device in response to a trigger action by the user. The trigger action may be a button, a tab, or unfolding the card. It should also be understood that while the disposable base or any item thereon may be trigger to emit the pre-programmed DTMF tone, the speaker accomplished the task of emitting the actual sound. Step (314) connecting the user with a telephone service provider. This may be a provider such as 10-10-220. Also, it may be a dial up phone card and the pin number may be automatically input via the DTMF tones emitted by the speaker.

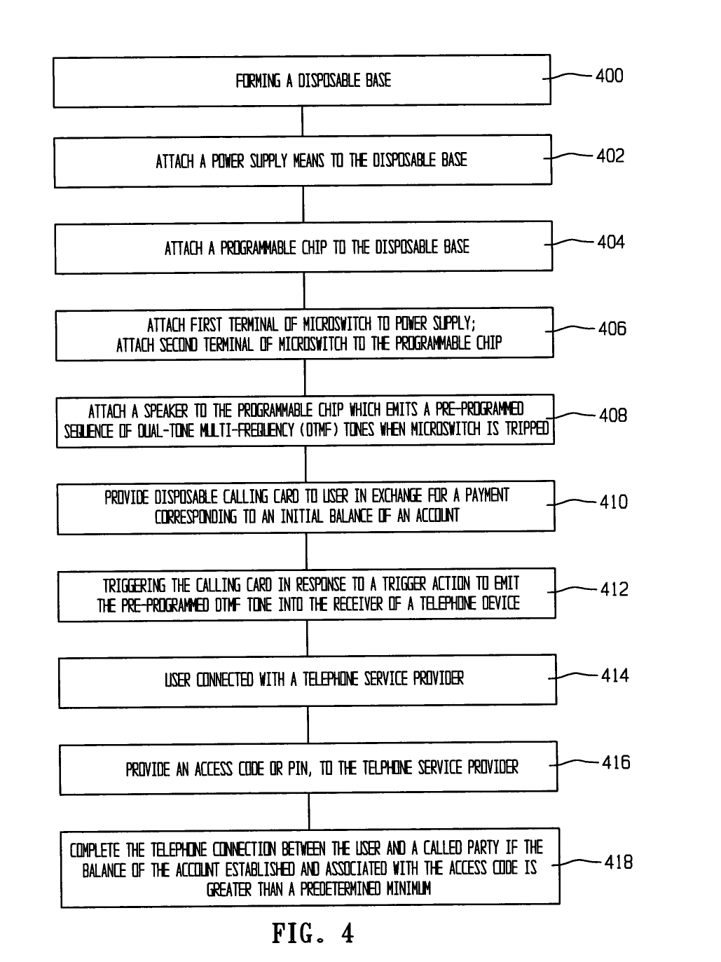

A method for providing and using a calling card is depicted in FIG. 4. The method comprising the steps of: (400) forming a disposable base; (402) attaching a power supply means to the disposable base; (404) attaching a programmable chip to the disposable base; (406) attaching a first terminal of a micro-switch to the power supply means and a second terminal of the micro-switch to the programmable chip; (408) attaching a speaker to the programmable chip which emits a pre-programmed sequence of Dual-Tone Multi-Frequency (DTMF) tones when said micro-switch is tripped; (410) providing the disposable calling card to a user in exchange for a payment corresponding to an initial balance of an account; (412) triggering the calling card in response to a trigger action to emit the pre-programmed DTMF tone into the receiver of a telephone device; and (414) connecting the user with a telephone service provider. The method may further comprise the steps (416) providing an access code, or pin, to the telephone service provider and step (418) completing a telephone connection between the user and a called party if the balance of the account established and associated with the access code is greater than a predetermined minimum. For instance, if there is a balance of 10 cents and the cost of connecting the call is 10 cents, the call will be completed. However, if the cost of connecting the call is greater than 10 cents, the call will not be completed. Where the balance of the account established is not greater than the predetermined minimum, the user may be directed to a provider who may accept payment to replenish the account.

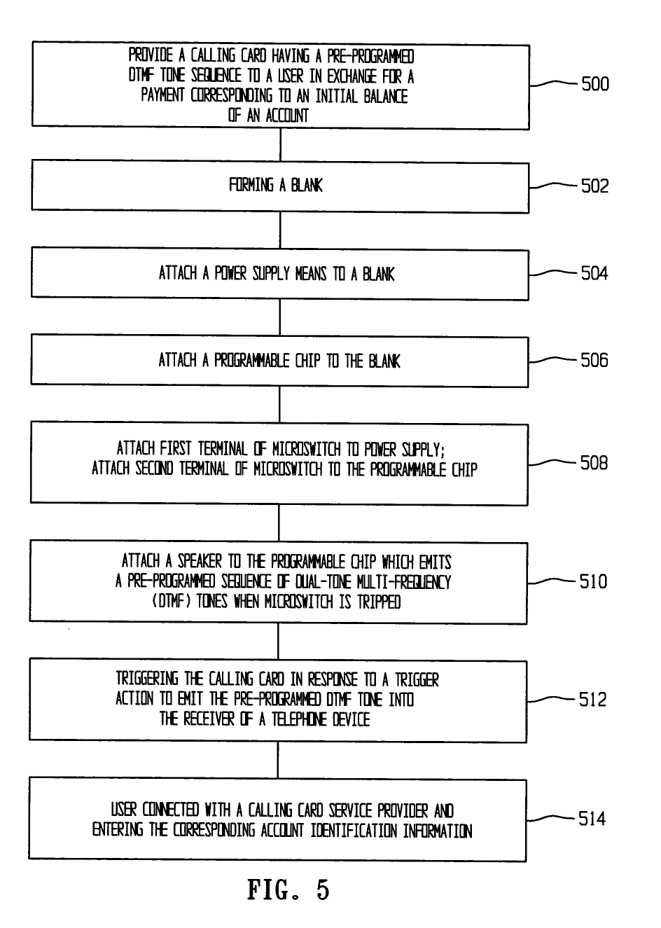

A method for providing and using a calling card is depicted in FIG. 5, comprises the steps of: step (500) providing a calling card having a pre-programmed DTMF tone sequence to a user in exchange for a payment corresponding to an initial balance of an account. This method may be further comprised of the step (502) forming a blank, step (504) attaching a power supply means to a blank; step (506) attaching a programmable chip to the blank; step (508) attaching a first terminal of a micro-switch to the power supply means and a second terminal of the micro-switch to the programmable chip; and step (510) attaching a speaker to said programmable chip which emits a pre-programmed sequence of Dual-Tone Multi-Frequency (DTMF) tones when said micro-switch is tripped. Step (512) triggering the calling card to emit the pre-programmed DTMF tone into the receiver of a telephone device in response to a trigger action by the user; The trigger action may be a button, a tab, or unfolding the card. Step (514) connecting the user with a calling card service provider and entering the corresponding account identification information. By the term entering the entering the corresponding account identification information this may mean the pre-programmed DTMF tone includes entering the access code or pin, or the user may manually dial the account identification information.

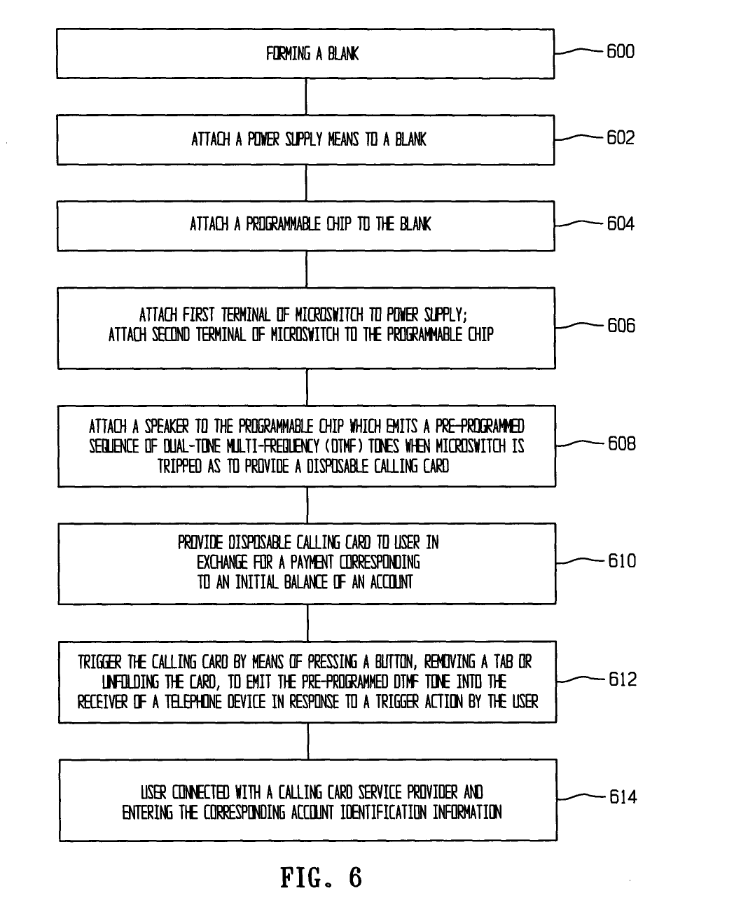

FIG. 6 depicts a method for providing and promoting a calling card, the method comprising the steps of: (600) forming a blank; (602) attaching a power supply means to the blank; (604) attaching a programmable chip to the blank; (606) attaching a first terminal of a micro-switch to the power supply means and a second terminal of the micro-switch to the programmable chip; (608) attaching a speaker to the programmable chip which emits a pre-programmed sequence of Dual-Tone Multi-Frequency (DTMF) tones when the micro-switch is tripped as to provide a disposable calling card; (610) providing the disposable calling card to a user in exchange for a payment corresponding to an initial balance of an account; (612) triggering the calling card, by means of pressing a button, removing a tab or unfolding the card, to emit the pre-programmed DTMF tone into the receiver of a telephone device in response to a trigger action by the user; and (614) connecting the user with a calling card service provider and entering the corresponding account identification information.

1. A method of manufacturing a disposable, DTMF tone emitting promotional item comprising:
providing a disposable base;
attaching a power supply means to said disposable base;
attaching a programmable chip to said disposable base;
attaching a first terminal of a micro-switch to said power supply and a second terminal of said micro-switch to said programmable chip;
providing a trigger means for tripping said micro-switch; and
attaching a speaker to said programmable chip which emits a pre-programmed sequence of Dual-Tone Multi-Frequency (DTMF) tones when said micro-switch is tripped.

2. A method as in claim 1, wherein said disposable base is selected from the group consisting a business card, standard business card, single fold business card, bi-fold business card, pen, pencil and key chain ornament.

3. A method as in claim 1, wherein said step of providing a disposable base provides a blank approximately the size of a business card.

4. A method as in claim 1, wherein said disposable base is a single fold business card, wherein said first terminal is attached to a portion of said single-fold, so as to activate said programmable chip upon unfolding said single-fold business card.

5. A method as in claim 1, wherein said disposable base is a bi-fold business card having, wherein said first terminal is attached to a portion of said bi-fold, so as to activate said programmable chip upon unfolding said bi-fold business card.

6. A method as in claim 1, wherein said disposable base is formed to provide a creased side and an open side, and upon unfolding said disposable base along said open side activates said speaker to play said series of pre-programmed DTMF tones.

7. A method as in claim 1, wherein said pre-programmed sequence is the telephone number for a telephone connection provider.

8. A method as in claim 1, further comprising the step of:
printing a third party provider's telephone number on said promotional item.

9. A method as in claim 1, further comprising the step of:
leaving a designated area on said promotional item where a third party's telephone number can be written.

10. A device for promoting and automatically dialing a phone number comprising:
a disposable base;
a power supply;
a programmable chip;
a micro-switch connected to said power supply and said programmable chip;
a trigger in communication with said micro-switch and said programmable chip; and
a speaker which emits a pre-programmed sequence of Dual-Tone Multi-Frequency (DTMF) tones which automatically dials a telephone connection provider when said micro-switch is tripped.

11. A device as in claim 10, wherein said disposable base is selected from the group consisting a business card, standard business card, single fold business card, bi-fold business card, pen, pencil and key chain.

12. A device as in claim 10, wherein said disposable base is a business card having a fold, and unfolding said card performs as said trigger to trip said micro-switch and activate said speaker to play said series of pre-programmed DTMF tones.

13. A device as in claim 10, wherein said trigger is selected from the group consisting of tabs, buttons, or switches.

14. A method for promoting a phone number, said method comprising the steps of:
providing a disposable base capable of emitting a pre-programmed DTMF tone sequence to a user in exchange for a payment corresponding to an initial balance of an account;
triggering said disposable base to emit said pre-programmed DTMF tone into the receiver of a telephone device in response to a trigger action by said user; and
connecting said user with a telephone service provider.

15. A method as in claim 14, wherein said disposable base is selected from the group consisting a business card, standard business card, single fold business card, bi-fold business card, pen, pencil and key chain.

16. A method as in claim 14, wherein said step of providing a disposable base comprises the steps of:
forming a blank;
attaching a power supply means to said blank;
attaching a programmable chip to said blank;
attaching a first terminal of a micro-switch to said power supply means and a second terminal of said micro-switch to said programmable chip;
attaching a speaker to said programmable chip which emits a pre-programmed sequence of Dual-Tone Multi-Frequency (DTMF) tones when said micro-switch is tripped.

17. A method as in claim 14, wherein said trigger action is selected from the group consisting of pressing a button, removing a tab, and unfolding said card.

18. A method for providing and using a calling card, said method comprising the steps of:
forming a disposable base;
attaching a power supply means to said disposable base;
attaching a programmable chip to said disposable base;
attaching a first terminal of a micro-switch to said power supply means and a second terminal of said micro-switch to said programmable chip;
attaching a speaker to said programmable chip which emits a pre-programmed sequence of Dual-Tone Multi-Frequency (DTMF) tones when said micro-switch is tripped;
providing the disposable calling card to a user in exchange for a payment corresponding to an initial balance of an account;
triggering said calling card in response to a trigger action to emit said pre-programmed DTMF tone into the receiver of a telephone device; and
connecting said user with a telephone service provider.

19. A method as in claim 18, wherein said disposable base is selected from the group consisting a business card, standard business card, single fold business card, bi-fold business card, pen, pencil and key chain ornament.

20. A method as in claim 18, further comprising the step of:
providing an access code to said telephone service provider.

21. A method as in claim 18, further comprising the step of:
completing a telephone connection between said user and a called party if said balance of said account associated with said access code is greater than a predetermined minimum.

22. A method for using a calling card, said method comprising the steps of:
providing a disposable calling card having pre-programmed DTMF tone sequence to a user in exchange for a payment corresponding to an initial balance of an account;
triggering said calling card to emit said pre-programmed DTMF tone into the receiver of a telephone device in response to a trigger action by said user; and
connecting said user with a calling card service provider and entering the corresponding account identification information

23. A method as in claim 22, wherein said step of providing a disposable calling card comprises the steps of:
forming a blank;
attaching a power supply means to said blank;
attaching a programmable chip to said blank;
attaching a first terminal of a micro-switch to said power supply means and a second terminal of said micro-switch to said programmable chip; and
attaching a speaker to said programmable chip which emits a pre-programmed sequence of Dual-Tone Multi-Frequency (DTMF) tones when said micro-switch is tripped.

24. A method as in claim 22, wherein said trigger action is selected from the group consisting of pressing a button, removing a tab, and unfolding said card.

25. A method for providing and promoting a calling card, said method comprising the steps of:
forming a blank;
attaching a power supply means to said blank;
attaching a programmable chip to said blank;
attaching a first terminal of a micro-switch to said power supply means and a second terminal of said micro-switch to said programmable chip;
attaching a speaker to said programmable chip which emits a pre-programmed sequence of Dual-Tone Multi-Frequency (DTMF) tones when said micro-switch is tripped as to provide a disposable calling card;
providing the disposable calling card to a user in exchange for a payment corresponding to an initial balance of an account;
triggering said calling card to emit said pre-programmed DTMF tone into the receiver of a telephone device in response to a trigger action by said user; and
connecting said user with a calling card service provider and entering the corresponding account identification information.
